(19) United States
(12) Patent Application Publication
(10) Pub. No.: US 2010/0297411 A1
(43) Pub. Date: Nov. 25, 2010

(54) Laminated Board

(76) Inventors: Cheng-Chung Tsai, Taichung City (TW); Chi-Lung Huang, Changhua County (TW)

Correspondence Address: CHARLES E. BAXLEY, ESQUIRE, 90 JOHN STREET, SUITE 309, NEW YORK, NY, 10038, US

(21) Appl. No.: 12/454,687

(22) Filed: May 21, 2009

(51) Int. Cl. B32B 7/02; B32B 13/04

(52) U.S. Cl. 428/213

(57) ABSTRACT

A laminated board includes a primary layer mainly made of magnesium oxide or magnesium sulfate, wherein the primary layer provides the laminated board with fireproof ability, moisture-proof ability and bendability.

### BACKGROUND OF THE INVENTION

1. Technical Field

The present invention relates to laminated boards, and more particularly, to a laminated board having a primary layer mainly made of magnesium oxide or magnesium sulfate, wherein the primary layer provides the laminated board with fireproof ability, moisture-proof ability and bendability.

2. Description of Related Art

Taiwan Patent No. M316288 has disclosed a ligneous laminated board that comprises an outer layer with a grain decorative surface, a PVC lining layer, and a base layer formed from a thin wooden plate that are laminated together in sequence. An adhesive layer is further provided at a bottom of the thin wooden plate. Besides, edges of the laminated board are processed to have the known tongue-and-groove structure so that two adjacent said laminated boards could be easily joined together. While having the PVC lining layer, the known laminated board is slightly flexible, light in weight and waterproof, thus being suitable for indoor decoration or furniture finishing. Furthermore, the adhesive layer allows a user to easily affix the laminated board outside objects, thereby facilitating DIY works. However, the aforementioned board incurs certain environmental concern because the PVC lining layer, which forms the greater part of the laminated board and is firmly sandwiched in the middle, is not recyclable.

On the other hand, Taiwan Patent No. M286255 has disclosed a flameproof floorboard with tongue-and-groove connectors. The floorboard is composed of a decorative layer, a flameproof layer and a base layer laminated in sequence. The upmost decorative layer is intended to be waterproof and wearproof, and may be realized by a melamine board, a printing board, a coating board, an engraved board, a block board, a plastic board, a resin board, a log board or a plywood board. The flameproof layer is typically made of stacked paper or fabric impregnated with fire retardant solution so as to be flameproof. The base layer forms a foundation of the laminated board and may be realized by a block board, an acrylic board, a resin board, a plastic board, a log board or a plywood board. The laminated board is advantageous for its good flame resistance out of the intermediate layer formed by stacked paper or fabric impregnated with fire retardant solution. However, in the case that the laminated board has its decorative layer and base layer made of acryl or the like, it causes pollution and harms the environment and human at the beginning it is produced.

### SUMMARY OF THE INVENTION

The present invention proposes a laminated board having a primary layer made of magnesium oxide or magnesium sulfate, and a surface layer that is bound with the primary layer and made of a material different from magnesium oxide and magnesium sulfate. Therein, the primary layer is mainly formed by magnesium oxide or magnesium sulfate, with at least 63% of magnesium oxide or at least 91% of magnesium sulfate. The disclosed laminated board thus has the following physical features in virtue of the primary layer:

Flameproof ability: the 5 mm primary layer of possesses a heat-resisting limit of 900° C., a thermal conductivity of 0.3 w/mk, a compressive strength of 14 Mpa and a specific gravity of 0.9-1.1 (kg/m³).

Moisture-proof ability: the primary layer has a wet distortion rate of 0.26% and a water absorbing rate of 15% while remaining its original shape after one-month immersion in water without deformation and swell.

Heat insulation: the primary layer has a heat resistance of 1.14 m²k/w.

Bendability: the primary layer has a standard bending strength of 18 pa, which increases to 22 Mpa when the primary layer is moisturized.

Sound insulation: a sound insulating wall constructed from the disclose laminated boards with the 95 mm primary layer provides a sound insulating effect equal to that of a 123 mm wall constructed from four layers of 12 mm gypsum boards, and also equal to that of a 150 mm standard solid-brick wall.

Besides, the laminated board of the present invention is light yet strong and has a weight as light as 8.8 kg/m² when being at a thickness of 10 mm, only one tenth of the weight of a standard solid-brick wall while providing an impact strength as high as 2 to 3 times of that of a gypsum wall at the same thickness.

The disclosed laminated board can be cut, sawed and trimmed into proper sizes at will. The board is flexible and may be bent to meet various surfaces. Also, the board is adaptive to be bound with surfaces of building walls, floors, upholstery and furniture.

According to the present invention, a laminated board comprises:

a primary layer made of magnesium oxide or magnesium sulfate,

a surface layer bound with an upper surface the primary layer by means of adhesion, wherein the surface layer is smaller than the primary layer in thickness and is bendable with the primary layer; and

an adhesive layer provided at a lower surface of the primary layer.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawing, wherein:

FIG. 1 is an exploded view of a laminated board according to the present invention having a primary layer and a surface layer;

FIG. 2 is a perspective view of the laminated board of FIG. 1;

FIG. 3 is a cross sectional view of the laminated board of FIG. 1;

FIG. 4 is a cross sectional view of the laminated board of FIG. 1 with a decorative layer attached thereto;

FIG. 5 is an exploded view of a laminated board according to the present invention having a primary layer, a surface layer and a cushion layer;

FIG. 6 is a perspective view of the laminated board of FIG. 5;

FIG. 7 is a cross sectional view of the laminated board of FIG. 5;

FIG. 8 is a schematic drawing showing the laminated board of the present invention formed with a tongue and a groove; and

FIG. 9 is a schematic drawing showing two laminated boards of the present invention combined by means of the tongue and the groove.

### DETAILED DESCRIPTION OF THE PREFERRED EMBODIMENTS

While preferred embodiments are provided hereinafter for illustrating the concept of the present invention as described above, it is to be understood that the components of the embodiments shown in the accompanying drawings are depicted for the sake of easy explanation and need not to be made in scale.

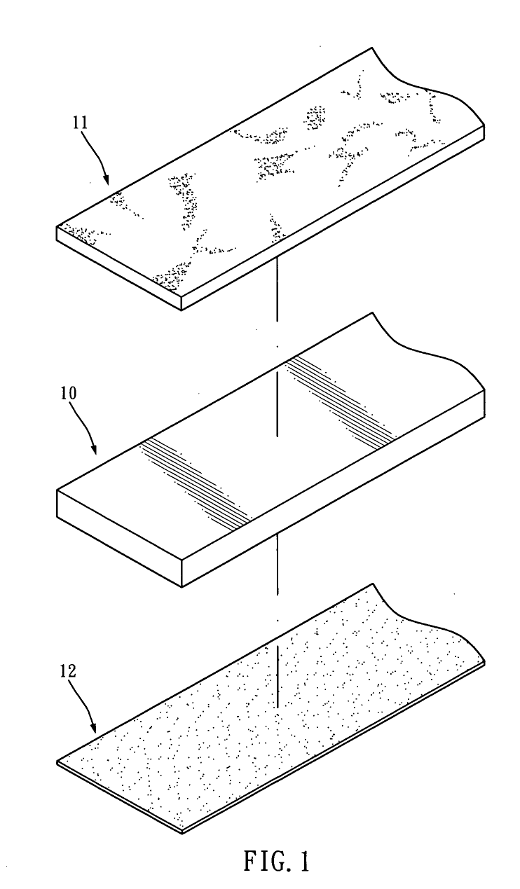

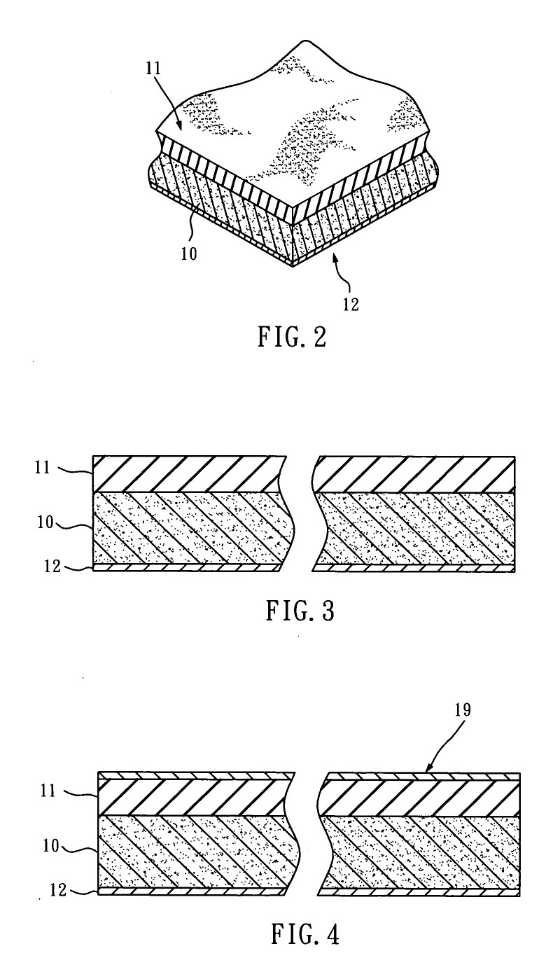

Referring to FIGS. 1 through 3, a laminated board according to the present invention mainly comprises a primary layer 10 and a surface layer 11 bound with an upper surface the primary layer 10 by means of adhesion. The primary layer 10 contains magnesium oxide or magnesium sulfate as the basic material, an natural inorganic material, such as fiber or perlite, added as filling stuff, and fiberglass mesh as well as nonwoven attached for reinforcing the whole board. The aforementioned combination possesses strength after initial setting and presents as a flexible yet tough board after dried. A preferred composition of the primary layer 10 includes 91 wt % (weight percents) of magnesium sulfate, 7 wt % of magnesium chloride and 2 wt % of neutralizer. An alternative preferred composition of the primary layer 10 includes 63 wt % of magnesium oxide, 4 wt % of wood fiber or cloth fiber, 15 wt % of perlite and 18 wt % of wood flour. The surface layer 11 is thinner than the primary layer 10 is bendable with the primary layer 10. The surface layer 11 may be a wooden board, a bamboo board or a wooden plywood. It is to be noted that the feasibility of using a slabstone as the surface layer 11 has not been eliminated by the present invention. An adhesive layer 12 is provided at a lower surface of the primary layer 10 so as to allow a user to easily affix the laminated board outside an external object.

As shown in FIG. 4, a decorative layer 19 may be further provided at a surface of the surface layer 11. The decorative layer 19 may be a painted veneer, a heat transfer film exhibiting patterns or colors, a wood veneer, or a plastic film made of PVC, PU, PET, PP, PE or PC for being adhered to the surface layer 11 for giving the laminated board an appearance simulating a particular material.

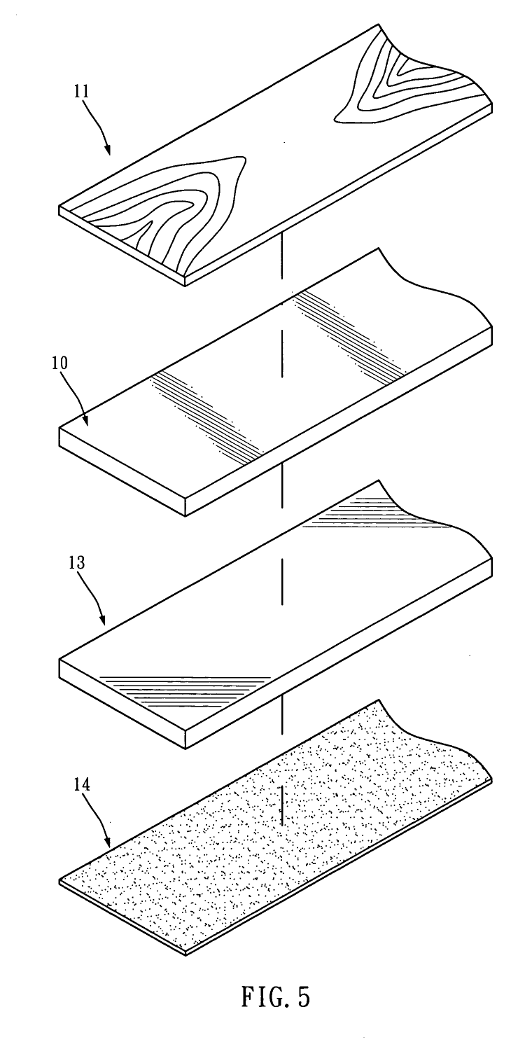

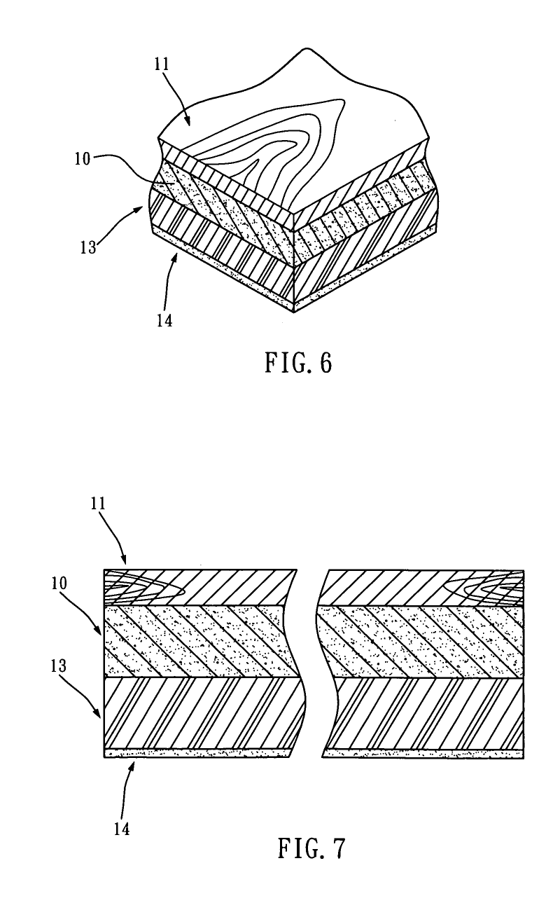

According to FIGS. 5, 6 and 7, a cushion layer 13 made of a shock-absorbing material (e.g. EVA, Ethylene-Vinylene Acetate copolymer) and having a thickness smaller than that of the primary layer 10 may be settled at the lower surface of the primary layer 10. Alternatively, the cushion layer 13 may be made of nonwoven. The cushion layer 13 provides the laminated board with shock-absorbing ability so as to adapt the laminated board to flooring applications. An adhesive layer 14 is provided at a lower surface of the cushion layer 13 so as to allow a user to easily affix the laminated board outside an external object.

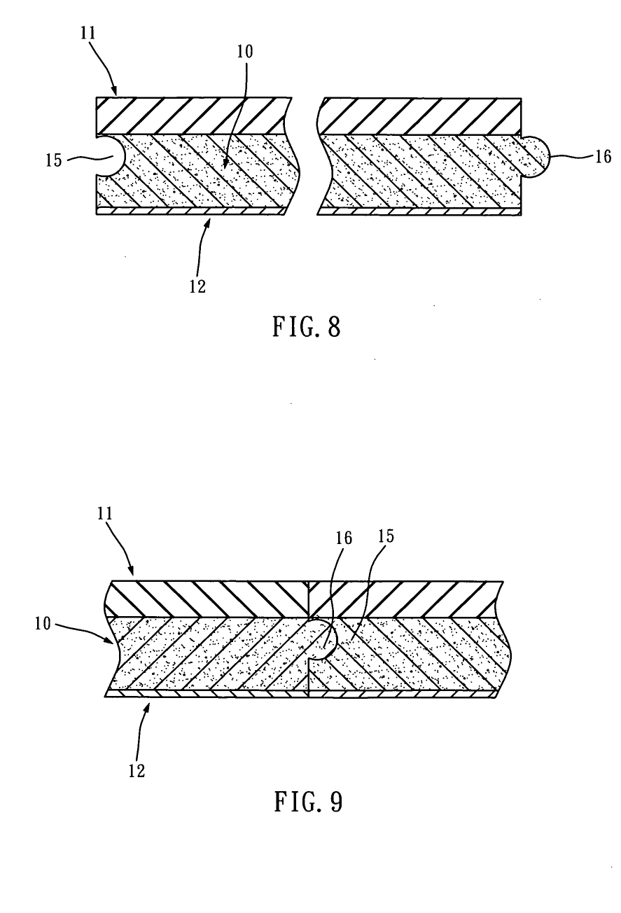

Seeing FIGS. 8 and 9, a groove 15 and a tongue 16 are provided at two opposite edges of the laminated board through any applicable known processing method so as to facilitate assembly between two adjacent said laminated boards.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A laminated board comprising:
a primary layer made of magnesium oxide or magnesium sulfate,
a surface layer bound with an upper surface of the primary layer by means of adhesion, wherein the surface layer has a thickness smaller than a thickness of the primary layer and is capable of bending with the primary layer; and
an adhesive layer provided at a lower surface of the primary layer.

2. The laminated board of claim 1, wherein the primary layer includes 91 weight percents of magnesium sulfate, 7 weight percents of magnesium chloride, and 2 weight percents of neutralizer.

3. The laminated board of claim 1, wherein the primary layer has includes 63 weight percents of magnesium oxide, 4 weight percents of wood fiber or cloth fiber, 15 weight percents of perlite, and 18 weight percents of wood flour.

4. The laminated board of claim 1, wherein the surface layer is a slabstone, a wooden board, a bamboo board or a wooden plywood.

5. The laminated board of claim 1, wherein a decorative layer is provided at a surface of the surface layer.

6. The laminated board of claim 5, wherein the decorative layer is a heat transfer film.

7. The laminated board of claim 5, wherein the decorative layer is a painted veneer.

8. The laminated board of claim 5, wherein the decorative layer is a wood veneer.

9. The laminated board of claim 5, wherein the decorative layer is a plastic film for being adhered to the surface layer and giving the laminated board an appearance simulating a particular material.

10. The laminated board of claim 1, wherein a cushion layer made of a shock-absorbing material is settled between the primary layer and the adhesive layer.

11. The laminated board of claim 10, wherein the cushion layer is made of EVA (Ethylene-Vinylene Acetate copolymer).

12. The laminated board of claim 10, wherein the cushion layer is made of nonwoven.
